(19) United States
(12) Patent Application Publication
(10) Pub. No.: US 2009/0029068 A1
(43) Pub. Date: Jan. 29, 2009

(54) CARBON THIN FILM MANUFACTURING METHOD AND CARBON THIN FILM COATED BODY

(76) Inventors: Takaaki KANAZAWA, Nisshin-shi (JP); Kenji Shimoda, Nagoya-shi (JP); Masaki Nanahara, Toyota-shi (JP); Hodo Suzuki, Hazu-gun (JP); Naoyuki Omori, Suita-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/180,027

(22) Filed: Jul. 25, 2008

(30) Foreign Application Priority Data
Jul. 26, 2007 (JP) 2007-195063

(51) Int. Cl. H05H 1/24

(52) U.S. Cl. 427/577

(57) ABSTRACT

A carbon thin film manufacturing method includes depositing an intermediate layer on a surface of a substrate, and forming a diamond-like carbon coating on a surface of the intermediate layer. In the carbon thin film manufacturing method, a bias voltage within a range of 0 V to −30 V is applied to the substrate during the deposition of the intermediate layer.

### INCORPORATION BY REFERENCE

The disclosure of Japanese Patent Application No. 2007-195063 filed on Jul. 26, 2007 including the specification, drawings and abstract is incorporated herein by reference in its entirety.

### BACKGROUND OF THE INVENTION

1. Field of the Invention

The present invention relates to a carbon thin film manufacturing method for forming a diamond-like carbon (DLC) coating (hard carbon thin film) on a substrate, and a carbon thin film coated body formed by this manufacturing method.

2. Description of the Related Art

Due to its high hardness and low friction coefficient, application of a diamond-like carbon coating (hereinafter, referred to as DLC coating) to a sliding portion is effective in achieving enhanced durability, reduced friction loss, and the like. In recent years, such a DLC coating has been frequently used as a protective film for various sliding members, tools, magnetic recording media, magnetic heads, and the like.

Due to the above-described characteristics, as shown in FIG. 10, a DLC coating 1 is used for, for example, a valve shaft 3 of a hydraulic valve 2 that performs fine hydraulic control and is thus actuated many times. Because the hydraulic valve 2 is actuated many times, if the DLC coating 1 is not applied to the valve shaft 3, wear or burning may occur because the valve shaft 3 and a valve seat 4 slide against each other. Further, erosion of a component surface by bubbles produced by a high speed flow of oil may result in damage due to cavitation. Such damage may reduce the sealing property of the hydraulic valve 2 and, depending on the case, even result in the loss of its function. To avoid this situation, as described above, the valve shaft 3 of the hydraulic valve 2 shown in FIG. 10 is coated with the DLC coating 1. In FIG. 10, the DLC coating 1 is formed on a surface of the valve shaft 3.

However, in the above-described example, loss of the DLC coating 1 due to its delamination from the valve shaft 3 may induce hydraulic pressure leakage, so it is desirable to improve the adhesion between the DLC coating 1 and the valve shaft 3. While the DLC coating 1 is formed on the surface of the valve shaft 3, the valve shaft 3 is used as a substrate at the time of deposition of the DLC coating 1, and the DLC coating 1 is deposited on top of the substrate. These two components, the substrate and the DLC coating 1, will hereinafter be referred to as a carbon-thin-film coated body 7 as appropriate. Also, a structure that further includes an intermediate layer interposed between the substrate and the DLC coating 1 will hereinafter be referred to as the carbon-thin-film coated body 7 as appropriate.

One conceivable way to improve adhesion is to provide an intermediate layer 6 made of metal between the substrate 5 and the DLC coating 1 (see Japanese Patent Application Publication No. 2004-183699 (JP-A-2004-183699)). However, when the carbon-thin-film coated body 7 includes the intermediate layer 6, configured as described above and as shown in FIG. 12, delamination of the DLC coating 1 often develops from the initiation point of fracture of the intermediate layer 6. Thus, the carbon-thin-film coated body 7 cannot exhibit satisfactory characteristics in terms of adhesion, and still leaves some room for improvement.

As another related art, Japanese Patent Application Publication No. 2002-88465 (JP-A-2002-88465) describes a technique in which a substrate (workpiece) is held on a rotary table of a non-equilibrium magnetron sputtering device, a workpiece holder that applies a bias voltage to the substrate (workpiece) is provided (see paragraph “0030” and FIG. 3 of JP-A-2002-88465), and when depositing an intermediate layer, the intermediate layer is deposited on a surface of the substrate (workpiece) by applying a voltage of about −0 to −50 V as a bias voltage to the workpiece holder (and therefore the substrate) (see paragraph “0054” and FIG. 6 of JP-A-2002-88465).

According to this deposition technique, after deposition is carried out until the intermediate layer is deposited to a predetermined film thickness, the power to the evaporation source of the intermediate layer is reduced stepwise with time, and at the same time, the power to the evaporation source of carbon is increased stepwise with time by voltage application to its electrode from a sputter power supply, thereby depositing, on top of the intermediate layer, a layer having a gradient structure in which the composition of metal of the intermediate layer and carbon of a hard carbon coating changes stepwise depending on the location across the film thickness. Then, when the power applied to the evaporation source of the intermediate layer becomes 0 W, the bias voltage to be applied to the substrate (work holder) is set to about −50 V to −700 V, and a hard carbon coating (DLC coating) is formed under this condition until a predetermined film thickness is reached (see paragraph “0054” and FIG. 6 of JP-A-2002-88465). According to this deposition technique, when depositing an intermediate layer, improved adhesion may be achieved by carrying out deposition with a bias of high negative voltage (a high negative voltage of about −500 V to −2000 V as a bias voltage) immediately after the start of deposition of the intermediate layer, and then reducing the bias stepwise to a lower negative voltage (about −0V to −50 V is desirable as the final bias voltage) (see paragraphs “0046” and “0047” of JP-A-2002-88465).

As in the technique described in JP-A-2004-183699, the carbon thin film coated body obtained by this deposition technique is also prone to delamination of the DLC coating 1 which develops from the initiation point of fracture of the intermediate layer 6 as shown in FIG. 12. Thus, the deposition technique described in JP-A-2002-88465 still leaves some room for improvement in terms of adhesion enhancement.

### SUMMARY OF THE INVENTION

The present invention provides a carbon thin film manufacturing method that can achieve enhanced adhesion. Also, the present invention provides a carbon thin film coated body having satisfactory adhesion.

A first aspect of the present invention relates to a carbon thin film manufacturing method including depositing an intermediate layer on a surface of a substrate, and forming a diamond-like carbon coating on a surface of the intermediate layer. In the carbon thin film manufacturing method, a bias voltage within a range of 0 V to −30 V is applied to the substrate during the deposition of the intermediate layer.

According to the configuration mentioned above, the intermediate layer is prevented from hardening excessively and thus exhibits increased ductility, which leads to enhanced ability to alleviate the stress and external force exerted from the diamond-like carbon coating deposited on top of the intermediate layer, thereby suppressing the formation of cracks within the intermediate layer which can lead to delamination.

In the carbon thin film manufacturing method according to the above-mentioned aspect, the bias voltage applied to the substrate may be further set to a fixed value within the range of 0 V to −30 V.

In the carbon thin film manufacturing method according to the above-mentioned aspect, the surface of the intermediate layer may be a surface on a side opposite to the substrate.

In the carbon thin film manufacturing method described above, the deposition of the intermediate layer may be carried out using a PVD method, in particular, a magnetron sputtering method.

The diamond-like carbon coating may be formed using either a PVD method or a CVD method.

A second aspect of the present invention relates to a carbon-thin-film coated body, manufactured using the above described method, that includes the intermediate layer formed on the surface of the substrate, and the diamond-like carbon coating formed on the surface of the intermediate layer. According to the above-mentioned configuration, the intermediate layer is prevented from hardening excessively and thus exhibits increased ductility, which prevents the formation of cracks in the intermediate layer and therefore prevents cracking of the diamond-like carbon coating, thereby achieving enhanced adhesion.

In the carbon-thin-film coated body according to the above aspect, the intermediate layer may include chromium (Cr). Also, the intermediate layer may further include tungsten carbide (WC). In the intermediate layer, the weight ratio of WC to Cr may increase with increasing distance from the substrate.

In the carbon-thin-film coated body according to the above aspect, the intermediate layer may have a hardness of 690 DH.

### BRIEF DESCRIPTION OF THE DRAWING

The foregoing and further features and advantages of the invention will become apparent from the following description of example embodiments with reference to the accompanying drawings, wherein like numerals are used to represent like elements and wherein:

FIG. 1A, FIG. 1B, and FIG. 1C show a carbon thin film manufacturing process according to an embodiment of the present invention, of which FIG. 1A shows a cleaning step, FIG. 1B shows an intermediate-layer deposition step, and FIG. 1C shows a hard carbon thin film (DLC coating) deposition step;

FIG. 2A and FIG. 2B show a magnetron sputtering device used in the manufacture of the carbon thin film shown in FIG. 1A, FIG. 1B, and FIG. 1C, of which FIG. 2A is a plan view of a partial cross section schematically showing its structure, and FIG. 2B is a side view of a partial cross section schematically showing its structure;

FIG. 3 is a view showing a state of a magnetron sputtering device used in the manufacture of the carbon thin film shown in FIG. 1A, FIG. 1B, and FIG. 1C in a substrate cleaning step;

FIG. 4A is a view showing a state of a magnetron sputtering device used in the manufacture of the carbon thin film shown in FIG. 1A, FIG. 1B, and FIG. 1C in an intermediate layer deposition step, and FIG. 4B is a diagram showing bias voltage and target output characteristics in the intermediate layer deposition step;

FIG. 5 is a view showing a state of a magnetron sputtering device used to manufacture the carbon thin film shown in FIG. 1A, FIG. 1B, and FIG. 1C in a DLC layer deposition step;

FIG. 6A is a cross-sectional view schematically showing a carbon thin film coated body obtained through the steps shown in FIG. 1A, FIG. 1B, and FIG. 1C, and FIG. 6B is a view showing external force and stress exerted when the carbon thin film coated body shown in FIG. 6A is used;

FIG. 7A is a flowchart illustrating an adhesion inspection according to an embodiment of the present invention, and FIG. 7B is a view schematically showing a photograph of a carbon thin film coated body that has been determined as defective through the visual inspection in FIG. 7A;

FIG. 8 is a diagram showing the correlation between the bias voltage and the rate of defective adhesion obtained through an adhesion inspection according to an embodiment of the present invention;

FIG. 9A is a schematic drawing created to show the characteristic features of a photograph of a carbon thin film coated body including a DLC delamination site obtained through a cross section investigation according to an embodiment of the present invention, and FIG. 9B is a bias voltage-intermediate layer hardness characteristic diagram showing the results of hardness measurement of an intermediate layer;

FIG. 10 is a cross-sectional view showing a hydraulic valve coated with a DLC coating according to an embodiment of the present invention;

FIG. 11 is a cross-sectional view showing an example of related art in which an intermediate layer is interposed between a substrate and a DLC coating; and

FIG. 12 is a cross-sectional view schematically showing how DLC delamination develops from the initiation point of fracture of the intermediate layer.

### DETAILED DESCRIPTION OF EMBODIMENTS

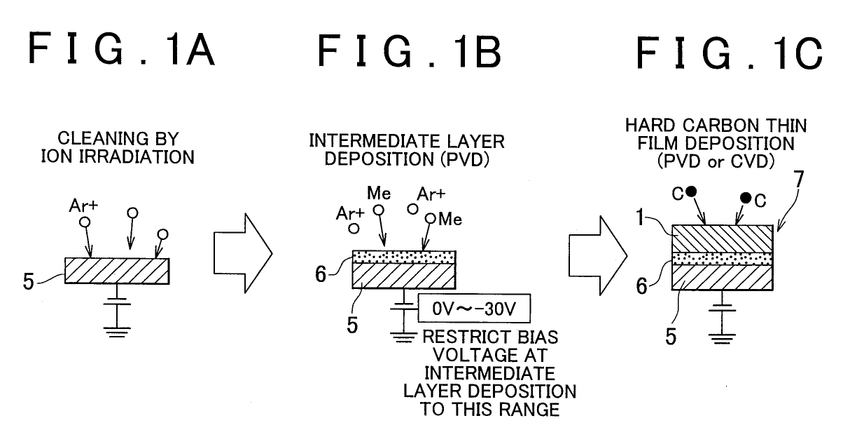

A carbon thin film manufacturing method according to an embodiment of the present invention will be described below with reference to FIG. 1A, FIG. 1B, and FIG. 1C through FIG. 6A and FIG. 6B. In FIG. 1A to FIG. 1C, reference numeral 5 denotes a substrate made of stainless steel, 6 an intermediate layer laminated on a surface of the substrate 5 by a magnetron sputtering method, and 1 a diamond-like carbon coating (DLC coating) laminated on a surface of the intermediate layer 6 on the side opposite to the substrate 5. Hereinafter, a combination of the substrate 5, the intermediate layer 6, and the DLC coating 1 is referred to as the carbon thin film coated body 7 as appropriate. The intermediate layer 6 includes Cr and WC.

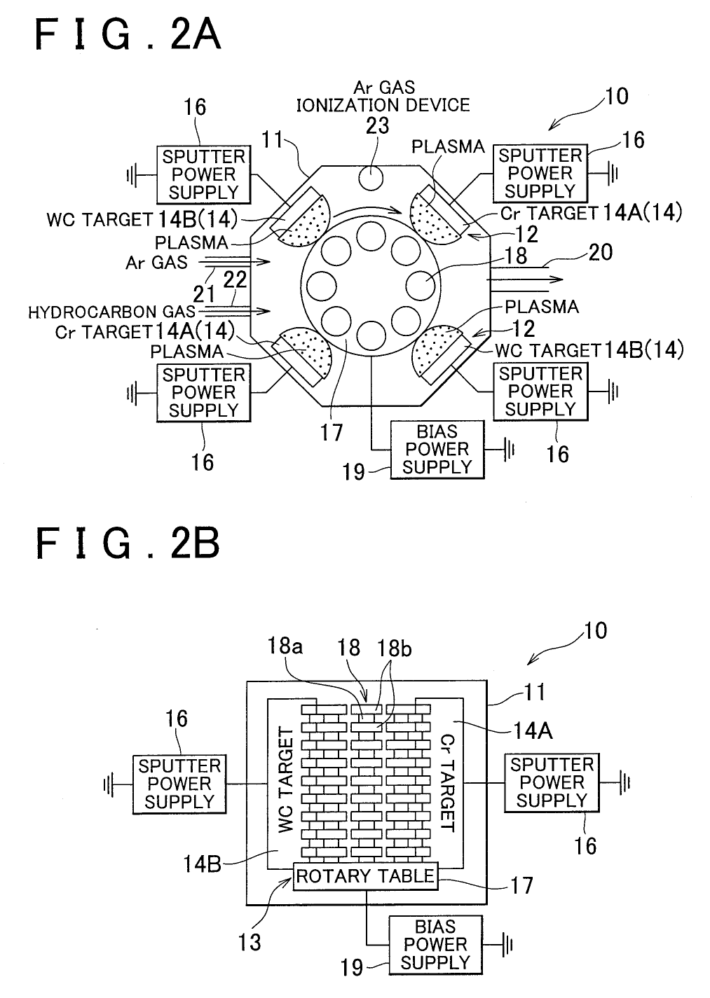

The carbon thin film-coated body 7 is produced using a magnetron sputtering device 10 shown in FIG. 2A and FIG. 2B. In FIG. 2A and FIG. 2B, the magnetron sputtering device 10 includes a vacuum chamber 11. Evaporation sources 12 are arranged at four locations on the periphery side inside the vacuum chamber 11. A substrate holder 13 that supports a large number of the substrates 5 is disposed at the center of the vacuum chamber 11. Of the evaporation sources 12 at four locations, a target 14 formed of Cr (hereinafter, referred to as a Cr target 14A) is provided in each of two diametrically disposed evaporation sources 12, and a target 14 formed of WC (hereinafter, referred to as a WC target 14B) is provided in each of the two remaining diametrically disposed evaporation sources 12. Each of the targets 14 (the Cr target 14A and the WC target 14B) is connected with a sputter power supply 16 arranged outside the vacuum chamber 11, and is applied with a negative bias voltage. The substrate holder 13 includes a rotary table 17 that is rotated clockwise as shown in FIG. 2A, for example, by driving means. A plurality of (in this embodiment, eight) rotary shafts 18, which are rotated clockwise by driving means as shown in FIG. 2A and FIG. 2B, are arrayed on the outer periphery of the rotary table 17. Each of the rotary shafts 18 includes a shaft body 18a, and a plurality of (in this embodiment, nine) substantially disc-like substrate placement portions 18b that project outwards from the shaft body 18a. The substrate placement portions 18b are provided along the longitudinal direction of the shaft body 18a. A plurality of the substrates 5 are each placed on the substrate placement portion 18b. As described above, as the rotary table 17 and the rotary shaft 18 rotate, each of the substrates 5 placed on the substrate placing portion 18b revolves around the axis of the rotary table 17 while rotating on its own axis. Further, a bias power supply 19 is connected to the substrate holder 13 so that a negative bias voltage including 0 V is applied to the substrate holder 13 and the substrate 5 held by the substrate holder 13.

The vacuum chamber 11 is provided with an exhaust port 20 for exhausting air from the vacuum chamber 11, an Ar gas inlet port 21 for introducing Ar gas into the vacuum chamber 11, and a hydrocarbon gas inlet port 22 for introducing hydrocarbon gas into the vacuum chamber 11. The exhaust port 20, the Ar gas inlet port 21, and the hydrocarbon gas inlet port 22 are connected to a vacuum pump, an Ar gas source, and a hydrocarbon gas source, respectively. Further, an Ar gas ionization device 23 is provided inside the vacuum chamber 11, and is used at the time of a cleaning step.

The deposition process ends when the carbon-thin-film coated body 7 is obtained after executing the following steps: an evacuation step ST1 for evacuating the vacuum chamber 11, a heating/degassing step ST2, a substrate cleaning step ST3, an intermediate layer deposition step ST4, a DLC layer deposition step ST5, and a cooling step ST6. Now, operation according to this embodiment will be described along with the steps mentioned above, with reference to FIG. 1A to FIG. 1C and FIG. 3 to FIG. 5 corresponding to these steps.

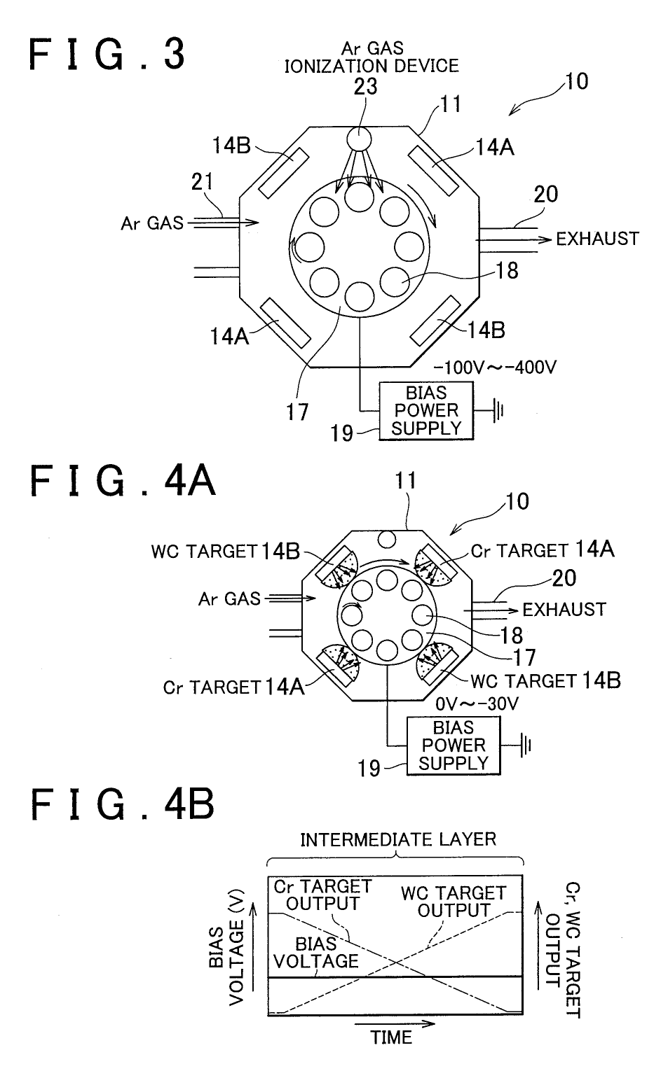

After the substrate 5 is placed on the substrate placing portion 18b, and the evacuation step ST1 and the heating/degassing step ST2 mentioned above are executed, in the substrate cleaning step ST3, as shown in FIG. 3, a bias voltage of “−100 V to −400 V” is applied to the substrate holder 13 from the bias power supply 19, and also the Ar gas ionization device 23 is actuated. Thus, as shown in FIG. 1A, the Ar gas is ionized, and the ionized Ar gas is attracted to the substrate 5 by the bias voltage, thereby removing contamination and oxide film on the substrate 5 by impact of the bombardment.

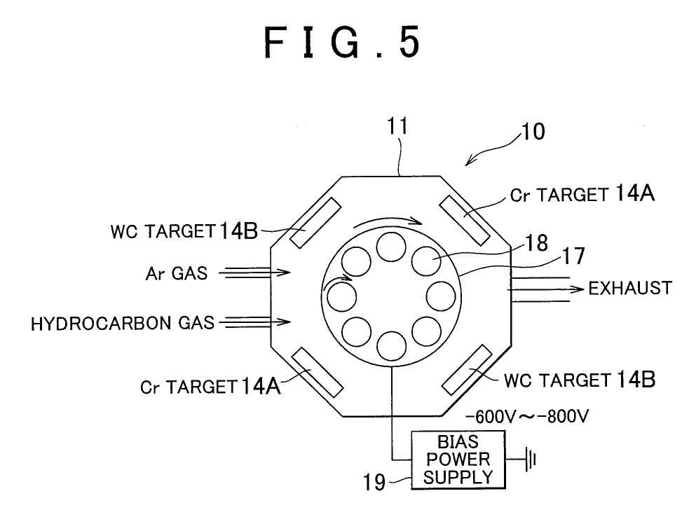

Subsequently, in the intermediate layer deposition step ST4, as shown in FIG. 1B and FIG. 4A, a bias voltage having a fixed value within a range of “0V to −30V” is applied to the substrate holder 13 from the bias power supply 19. During the initial stage of this step, as shown in FIG. 4B, power is supplied to only the Cr target 14A, and then gradually the power supplied to the WC target 14B is increased and the power supply to the Cr target 14A is reduced, so that at the final stage of this step, the power supplied to the Cr target 14A is zero. Meanwhile, plasma is generated between the respective targets 14, and as shown in FIG. 1B, Ar ions are also released together with material particles (Cr, WC) (indicated by Me in FIG. 1B). It should be noted that FIG. 4B shows that the absolute value of a negative bias voltage increases in the direction of the arrow.

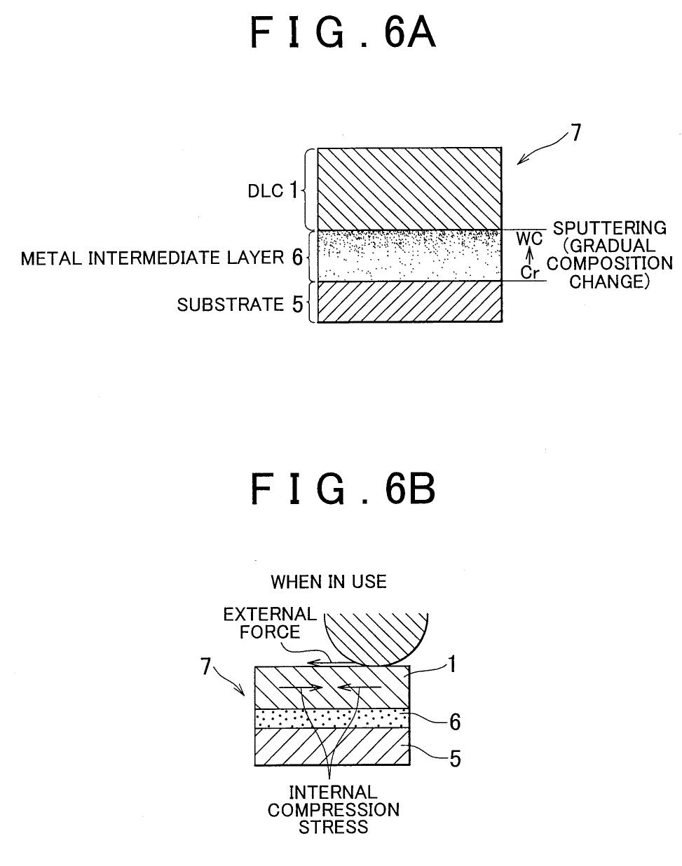

When power is supplied to each target 14 as described above, Cr atoms and WC atoms are knocked out from the Cr target 14A and the WC target 14B, respectively. The knocked-out Cr atoms and WC atoms are attracted toward the substrate 5, and deposit on the substrate 5 while being mixed together, forming the intermediate layer 6 containing a Cr component and a WC component. At this time, Ar ions have been released, which assists in efficient formation of the intermediate layer 6. Further, as shown in FIG. 4B, in accordance with the passage of time, the power supply to the Cr target 14A is reduced, and the power supply to the WC target 14B is increased. Thus, the composition of the intermediate layer 6 is formed while having gradual changes with respect to the Cr component and the WC component, in such a way that the WC component increases in the direction in which the film thickness increases, in other words, in such a way that the weight ratio of WC to Cr increases as the distance from the substrate 5 increases in the intermediate layer 6. It should be noted that FIG. 6A schematically shows such a gradual change in the composition of the intermediate layer 6 in which the WC component increases in the direction in which the film thickness increases with respect to the intermediate layer 6.

Subsequently, in the DLC layer deposition step ST5, as shown in FIG. 1C and FIG. 5, a voltage having a fixed value within a range of “−600V to −800 V” is applied to the substrate holder 13 from the bias power supply 19, to generate plasma around the substrate holder 13. Hydrocarbon gas introduced into the vacuum chamber is decomposed by the plasma to deposit a DLC coating (plasma CVD method). Accordingly, as shown in FIG. 6A, deposition is completed, forming the carbon thin film coated body 7. Subsequently, in the cooling step ST6, the carbon thin film coated body 7 is cooled, making it ready for shipment.

Because the intermediate layer 6 of the carbon thin film coated body 7 is deposited by setting the bias voltage applied to the substrate 5 to a fixed value within a range of 0 V to −30 V, the intermediate layer 6 does not harden excessively, and exhibits high ductility. Further, as shown in FIG. 6B, when in use, the intermediate layer 6 exhibits enhanced ability to alleviate stress and external force exerted from the DLC coating 1 deposited on top of the intermediate layer 6. Thus, the occurrence of cracks within the intermediate layer 6, which can lead to delamination of the carbon thin film coated body 7, is suppressed and thereby allows the carbon thin film coated body 7 to exhibit superior adhesion of the carbon-thing-film coating to the substrate 5.

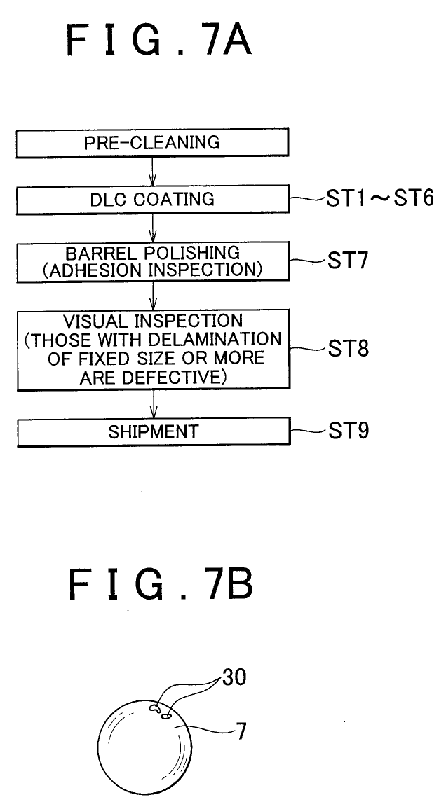

In order to avoid a situation where, after the carbon thin film coated body 7 is obtained as described above (the intermediate layer deposition step ST4, the DLC layer deposition step ST5, and the cooling step ST6), defective pieces of the carbon thin film coated body 7 in terms of adhesion (defective adhesion pieces) are passed to the subsequent steps, as shown in FIG. 7A, barrel polishing (adhesion inspection) (barrel polishing step ST7) and visual inspection (visual inspection step ST8) are carried out, and only those pieces of the carbon thin film coated body 7 that are determined to be “non-defective” in the above-mentioned two steps of the barrel polishing step ST7 and the visual inspection step ST8 are shipped (shipment step ST9). In FIG. 7A, the steps ST1 to ST6 are collectively indicated as a DLC coating step.

In the barrel polishing step ST7, the carbon-thin-film coated body 7 to be inspected and a large number of grindstones having a spherical shape, for example, are filled in a barrel and agitated, the carbon-thin-film coated body 7 is polished using the barrel polishing technique, and defective adhesion sites are made apparent by the polishing force. In the visual inspection step ST8 that follows the barrel polishing step ST7, it is determined by visual observation whether the delaminated sites are equal to or exceed a predetermined size. FIG. 7B is a view schematically showing a photograph of the carbon-thin-film coated body 7 that has been determined as defective due to its low adhesion. In the drawings, reference numeral 30 denotes sites where delamination has occurred. Because the carbon-thin-film coated body 7 shown in FIG. 7B has low adhesion, delamination occurs due to the force exerted upon barrel polishing. In other words, the adhesion of the carbon-thin-film coated body 7 is inspected through the barrel polishing carried out in the barrel polishing step ST7.

As a result of intensive studies made on the adhesion of the diamond-like carbon coating (DLC coating 1) deposited on the substrate 5 via the intermediate layer 6, it was found through the following inspection that there is a close correlation between the bias voltage applied to the substrate 5 during the deposition of the intermediate layer 6 and the adhesion of the DLC coating 1, and that the adhesion of the DLC coating 1 improves if the deposition of the intermediate layer 6 is carried out by setting the bias voltage applied to the substrate 5 to a fixed value within a range of 0 V to −30 V.

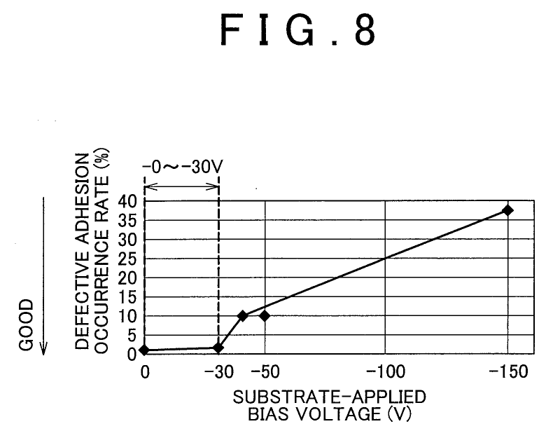

The intermediate layer 6 was deposited by setting the bias voltage applied to the substrate 5 to various values (specifically, 0V, −30V, −40V, −50V, and −150V), and then the DLC coating 1 was deposited in the same manner as in the above-described embodiment to obtain a number of samples of the carbon-thin-film coated body 7. Specifically, 200 pieces of the carbon-thin-film coated body 7 were obtained with respect to each set voltage for inspection. Then, their adhesion was inspected by using the barrel polishing method described above. As a result of this inspection, as shown in FIG. 8, for pieces of the carbon-thin-film coated body 7 having the intermediate layer 6 deposited by applying a bias voltage of −150 V to the substrate 5, the proportion of pieces determined to have defective adhesion (defective adhesion occurrence rate) was approximately 40%. Likewise, for respective pieces of the carbon-thin-film coated body 7 in which the intermediate layer 6 was deposited at bias voltages of −50 V, −40 V, −30 V, and 0 V to the substrate 5, their defective adhesion occurrence rates were approximately 10%, approximately 10%, approximately 1%, and approximately 1%, respectively.

Then, as is apparent from FIG. 8, it was appreciated that while the adhesion of the DLC coating 1 is poor when the intermediate layer 6 is deposited by applying to a negative bias voltage, whose absolute value is greater than absolute value of −30 V, to the substrate 5. However, the adhesion of the DLC coating 1 is improved when the intermediate layer 6 is deposited by applying a fixed bias voltage within a range of 0 V to −30 V to the substrate 5.

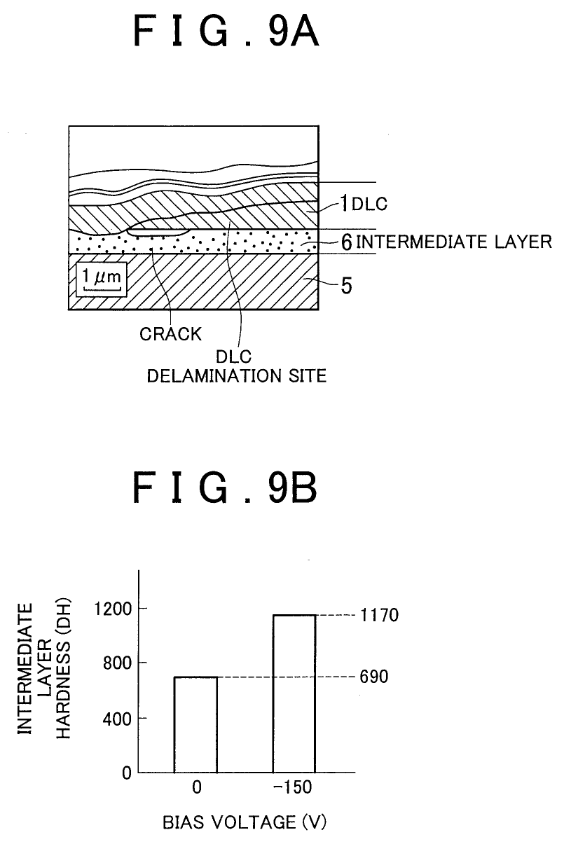

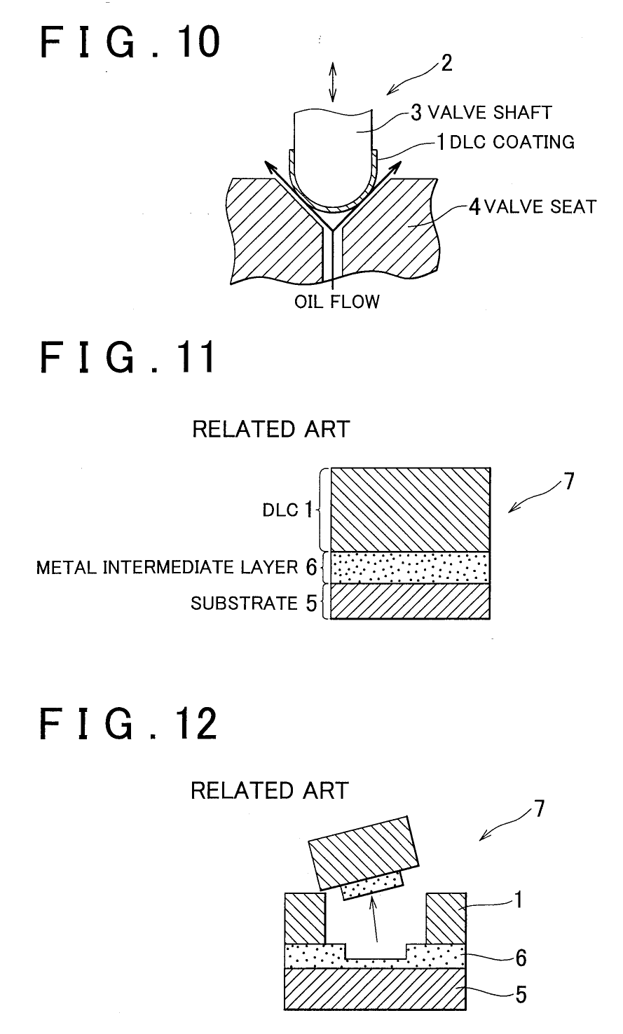

Further, in order to ascertain the reason for the reduction in defective adhesion realized by setting the bias voltage in the manner mentioned above (setting a fixed bias voltage within a range of 0V to −30 V) at the deposition of the intermediate layer 6, the present inventors carried out an investigation of the cross section of a DLC delamination site with respect to the carbon-thin-film coated body 7 that was determined to be defective by the above-mentioned inspection, and measurement of the hardness of the intermediate layer 6 with respect to pieces of the carbon-thin-film coated body 7 obtained by setting the bias voltage to −150 V and 0V. The results of the cross section investigation revealed that as shown in FIG. 9A, a crack developed inside the intermediate layer 6 of the carbon-thin-film coated body 7, and delamination has proceeded (the site where delamination has occurred is referred to as a DLC delamination site). In the cross section investigation, a photograph was taken of the carbon-thin-film coated body 7, including a DLC delamination site. FIG. 9A is a schematic illustration of the characteristic features of the photographed content.

The results shown in FIG. 9B were obtained from the hardness measurement of the intermediate layer 6. Further, as shown in FIG. 9B, the following findings (i) and (ii) were established: (i) when the bias voltage is −150V, the intermediate layer 6 is hard (its hardness is 1170 (DH)) and brittle, and hence liable to crack; and (ii) when the bias voltage is 0V, the intermediate layer 6 is soft (its hardness is 690 (DH)) and exhibits ductile characteristics, which suppresses occurrence of fracture initiation. The present invention has been made on the basis of the findings obtained from the above-described inspection results (FIG. 8), the cross section investigation (FIG. 9A), the hardness measurement of the intermediate layer 6 (FIG. 9B), and enhances adhesion as described above.

While in this embodiment the bias voltage applied to the substrate 5 is a fixed voltage within a range of 0 V to −30 V, the present invention is not limited to this. The bias voltage may be varied as long as it falls within a range of 0 V to −30 V.

While example embodiments of the invention have been described above, it is to be understood that the invention is not limited to details of the described embodiments, but may be embodied with various changes, modifications or improvements, which may occur to those skilled in the art, without departing from the scope of the invention.

What is claimed is:

1. A carbon thin film manufacturing method comprising:
depositing an intermediate layer on a surface of a substrate;
forming a diamond-like carbon coating on a surface of the intermediate layer; and
wherein a bias voltage within a range of 0 V to −30 V is applied to the substrate during the deposition of the intermediate layer.

2. The carbon thin film manufacturing method according to claim 1, wherein the bias voltage applied to the substrate is set to a fixed value within the range of 0 V to −30 V.

3. The carbon thin film manufacturing method according to claim 1, wherein the surface of the intermediate layer is a surface on a side opposite to the substrate.

4. The carbon thin film manufacturing method according to claim 1, wherein the deposition of the intermediate layer is carried out by a PVD method.

5. The carbon thin film manufacturing method according to claim 4, wherein the PVD method is a magnetron sputtering method.

6. The carbon thin film manufacturing method according to claim 1, wherein the formation of the diamond-like carbon coating is carried out by one of a PVD method and a CVD method.

7. A carbon thin film coated body manufactured using the carbon thin film manufacturing method according to claim 1, comprising the intermediate layer formed on the surface of the substrate, and the diamond-like carbon coating formed on the surface of the intermediate layer.

8. A carbon thin film coated body manufactured using the carbon thin film manufacturing method according to claim 2, comprising the intermediate layer formed on the surface of the substrate, and the diamond-like carbon coating formed on the surface of the intermediate layer.

9. A carbon thin film coated body manufactured using the carbon thin film manufacturing method according to claim 3, comprising the intermediate layer formed on the surface of the substrate, and the diamond-like carbon coating formed on the surface of the intermediate layer.

10. A carbon thin film coated body manufactured using the carbon thin film manufacturing method according to claim 4, comprising the intermediate layer formed on the surface of the substrate, and the diamond-like carbon coating formed on the surface of the intermediate layer.

11. A carbon thin film coated body manufactured using the carbon thin film manufacturing method according to claim 5, comprising the intermediate layer formed on the surface of the substrate, and the diamond-like carbon coating formed on the surface of the intermediate layer.

12. A carbon thin film coated body manufactured using the carbon thin film manufacturing method according to claim 6, comprising the intermediate layer formed on the surface of the substrate, and the diamond-like carbon coating formed on the surface of the intermediate layer.

13. The carbon thin film coated body according to claim 7, wherein the intermediate layer includes Cr.

14. The carbon thin film coated body according to claim 13, wherein the intermediate layer further includes WC.

15. The carbon thin film coated body according to claim 14, wherein in the intermediate layer, a weight ratio of WC to Cr increases with increasing distance from the substrate.

16. The carbon thin film coated body according to claim 7, wherein the intermediate layer has a hardness of 690 DH.
